(19) United States
(12) Patent Application Publication
(10) Pub. No.: US 2009/0187265 A1
(43) Pub. Date: Jul. 23, 2009

(54) PROCESS MANUFACTURING WITH PRODUCT QUANTITY CALCULATION

(75) Inventors: Elaine WAN, San Jose, CA (US); Thomas Daniel, Ossining, NY (US); Kapil Motupalli, Andhra Pradesh (IN); Rahul Krishan, Jammu (IN); Rajendar Nalla, Pomona, NY (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/018,620

(22) Filed: Jan. 23, 2008

(51) Int. Cl. G06F 19/00

(52) U.S. Cl. 700/106

(57) ABSTRACT

A system that determines product quantities for a process manufacturing formula that generates a first product and a second product receives a quantity of a first ingredient and a quantity of a second ingredient. The first and second ingredients contribute to a formula yield. The system further receives a quantity of a byproduct of the formula and a percentage of the formula for the output first product and a percentage of the formula for the output second product. The system then automatically determines a first product quantity based on the quantity of the first ingredient, the quantity of the second ingredient, the quantity of the byproduct of the formula, and the percentage of the formula for the first product.

### FIELD OF THE INVENTION

One embodiment is directed generally to process manufacturing, and in particular to a product quantity calculation for process manufacturing.

### BACKGROUND INFORMATION

Process manufacturing is a branch of manufacturing that is associated with formulas or manufacturing recipes, and is common in the food, beverage, chemical, pharmaceutical, consumer packaged goods and biotechnology industries. Many corporations have research and product development labs in which new formulas are simulated before they are implemented. Part of the simulation typically involves calculating a theoretical yield of the new formulas.

### SUMMARY OF THE INVENTION

One embodiment is a system that determines product quantities for a process manufacturing formula that generates a first product and a second product. The system receives a quantity of a first ingredient and a quantity of a second ingredient. The first and second ingredients contribute to a formula yield. The system further receives a quantity of a byproduct of the formula and a percentage of the formula for the output first product and a percentage of the formula for the output second product. The system then automatically and dynamically determines a first product quantity based on the quantity of the first ingredient, the quantity of the second ingredient, the quantity of the byproduct of the formula, and the percentage of the formula for the first product and the second product. The determining is performed dynamically upon a change in any of the quantities. Embodiments can determine product quantities for any number of ingredients, byproducts, and output products.

### BRIEF DESCRIPTION OF THE DRAWINGS

FIG. 1 is a block diagram of a system for implementing one embodiment of the present invention.

FIG. 2 illustrates a user interface that receives product development parameters in accordance with one embodiment.

FIG. 3 illustrates a user interface to input formula details in accordance with one embodiment.

FIG. 4 is a flow diagram of the functionality of the system in accordance with one embodiment when determining product quantity for a formula that results in at least two products.

### DETAILED DESCRIPTION

One embodiment is a system that automatically determines the formula total product quantity of multiple products based on ingredient quantities and byproducts quantity. In one embodiment, the product quantity is dynamically calculated as a sum of the remaining ingredient quantities after removal of any byproducts quantity. The quantity is automatically calculated when ingredient quantities are changed. This calculation assists process manufacturing formulators to fine tune a formula during the research process for process manufacturing.

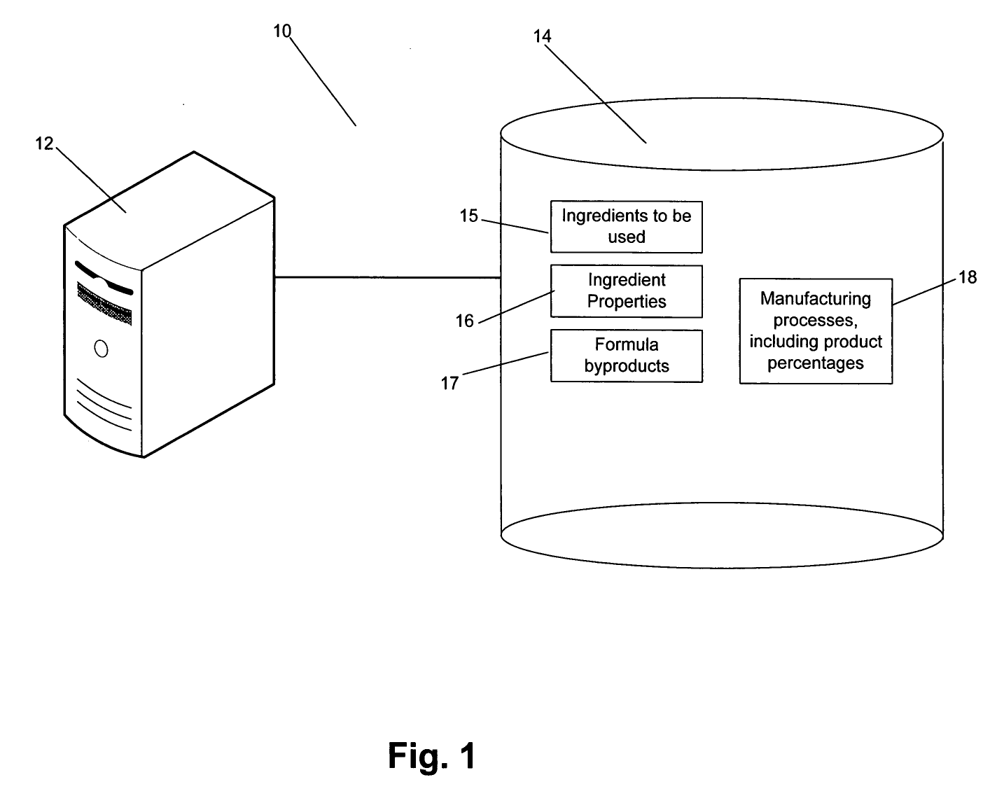

FIG. 1 is a block diagram of a system 10 for implementing one embodiment of the present invention. System 10 includes a server computer 12 coupled to a database 14. Server 12 can be any type of general purpose computer or any type of computing device that can execute instructions. Server 12 includes a processor, and memory for storing instructions that are executed by the processor. Server 12 is coupled to database 14. Server 12 can be directly coupled to database 14 or remotely coupled using any coupling method and via any type of network.

memory of server 12 can be comprised of any combination of random access memory (“RAM”), read only memory (“ROM”), static storage such as a magnetic or optical disk, or any other type of computer readable media. Computer readable media may be any available media that can be accessed by the processor of computer 12, and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Database 14 provides input parameters to server 12. Database 14 can be any type of storage device, and can be part of an overall system that generates or compiles the parameters through any method. In one embodiment, database 14 and server 12 are part of an Enterprise Resource Planning (“ERP”) system. In general, an ERP system integrates most or all data and processes of an organization into a unified system. A typical ERP system will use multiple components of computer software and hardware to achieve the integration. An ERP system typically includes a unified database, such as database 14, to store data for the various system modules. The system modules may include inventory, planning and scheduling, costing, approvals management, accounts payable, etc. In one embodiment, the ERP system is the “Oracle Process Manufacturing” ERP system from Oracle Corp.

In one embodiment, database 14 stores the input parameters 15-18 shown on FIG. 1 that are examples of inputs that can be used by server 12 to determine a product quantity calculation. In other embodiments, additional or less input parameters are stored by database 14 and used by server 12. In addition, in other embodiments any parameter used as input by server 12 to generate the product quantity calculation may be inputted by a user, generated by server 12 based on other inputs, received from another system in addition to an ERP system, or input to system 12 in any other manner.

Input parameters 15-18 in one embodiment include the ingredients 15 to be used for a formulation for a product. For example, if the formulation is for a cheese product, the ingredients may include cheddar, curd, whey and butter. Another input parameter is the ingredient properties 16, which are the raw properties of the ingredients. For example, for a specific type of cheddar cheese, the properties may include the fat content, moisture content, protein content, etc. The formula byproducts 17 parameter are the byproducts (i.e., unusable materials) that result from a given formula. The manufacturing processes 18 are the details on how each product is manufactured. For example, for a cheese product, the manufacturing processes will specify the machinery involved and the specific manufacturing steps that are required to manufacture the cheese product. For manufacturing processes and formulas that result in multiple products, the percentage of each product that results from the formula is also specified.

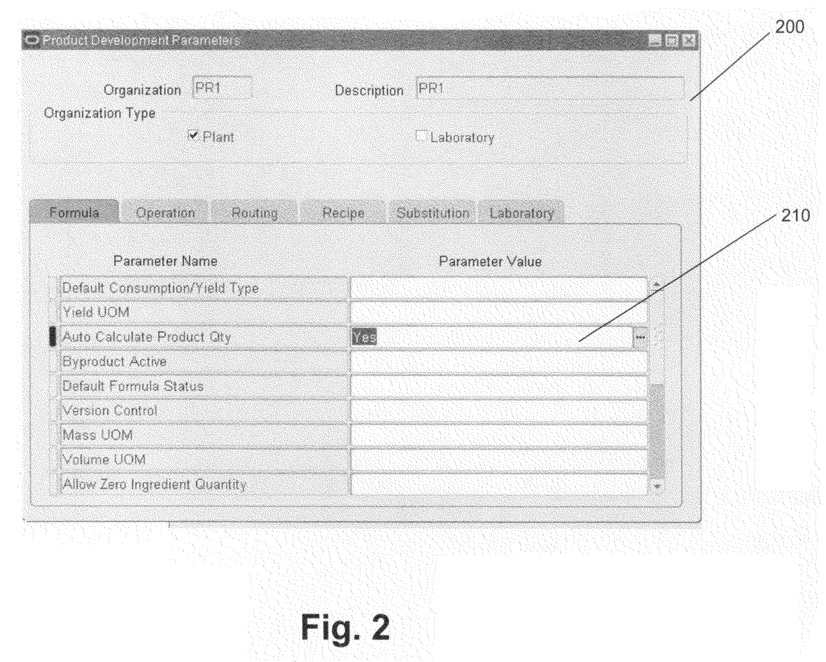

In one embodiment, system 10 includes user interfaces that allow a user to input product development parameters and set default values so that system 10 automatically calculates product quantity. FIG. 2 illustrates a user interface 200 that receives product development parameters in accordance with one embodiment. One of the parameters is entered in field 210, which allows the user to enable system 10 to automatically calculate product quantities. In one embodiment, when a user indicates “yes” at field 210, the product quantity (total of ingredient quantity) is dynamically calculated. For example, once the user changes the quantity of an ingredient in a user interface and then moves to another field, the product quantities are automatically calculated and updated. In one embodiment, this is applicable for every addition, deletion and change of quantity for items contributing to yield quantity or units of measure or contribute to yield value and change of the percentages of products. Therefore, the user can calculate the product quantity while entering formula details.

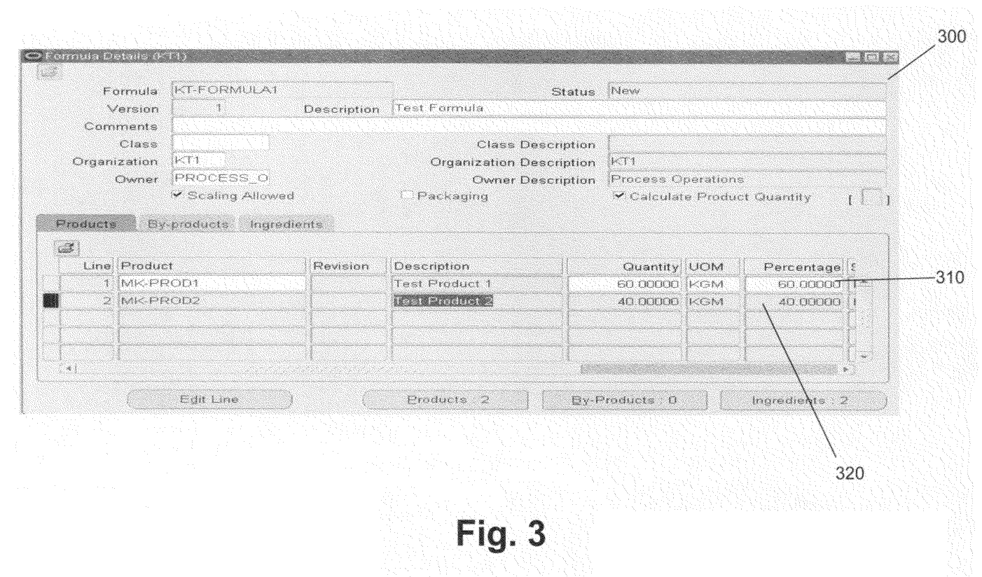

In one embodiment, the formula results in multiple products. FIG. 3 illustrates a user interface 300 to input formula details in accordance with one embodiment. User interface 300 includes fields 310 and 320 which allow the user to enter the percentages in which the formula quantity is to be distributed among multiple products. In case of any fixed products, in which the quantity of output products remain constant in spite of a proportional increase or decrease of product, byproduct, and ingredient quantities in a formula or batch, the user specifies the quantity, which will be subtracted from the total ingredient quantity. This quantity is later divided among the proportional products according to the percentages specified.

As an example of a product quantity calculation in accordance with one embodiment, assume Ingredient A is mixed with Ingredient B and Ingredient C to yield Product A and Product B. The process also produces a Byproduct A. Ingredient C is a catalyst and does not contribute to the yield. The following is an example of automatic calculation of the formula product quantity for this mixture in accordance with one embodiment:

| | | Qty | | Cont To | Calc |
|---|---|---|---|---|---|
| Material | Type | Entered | Percentages | Yield? | Quantity |
| Ingredient A | Ingredient | 40 LB | N/A | Yes | 40 LB |
| Ingredient B | Ingredient | 60 LB | N/A | Yes | 60 LB |
| Ingredient C | Ingredient | 20 LB | N/A | No | 20 LB |
| Byproduct A | Byproduct | 10 LB | N/A | | 10 LB |
| Product A | Product | — | 60 | | 54 LB |
| Product B | Product | — | 40 | | 36 LB |

The product quantity for Product A is calculated as:

[(Sum of Contributing Ingredient Quantities−Sum of Byproduct Quantities)*Percentage Entered for Product A)]/100

(40 LB+60 LB−10 LB)*(60/100)=54 LB.

Similarly Product B's calculated quantity is:

(40 LB+60 LB−10 LB)*(40/100)=36 LB.

In the case of any product with fixed scale type, the fixed quantity needs to be specified instead of the percentages. This quantity is subtracted and then available for applying the percentages.

Although the above example has two contributing ingredients and two output products, embodiments of the invention can determine the product quantity for any number of ingredients, byproducts, and output products.

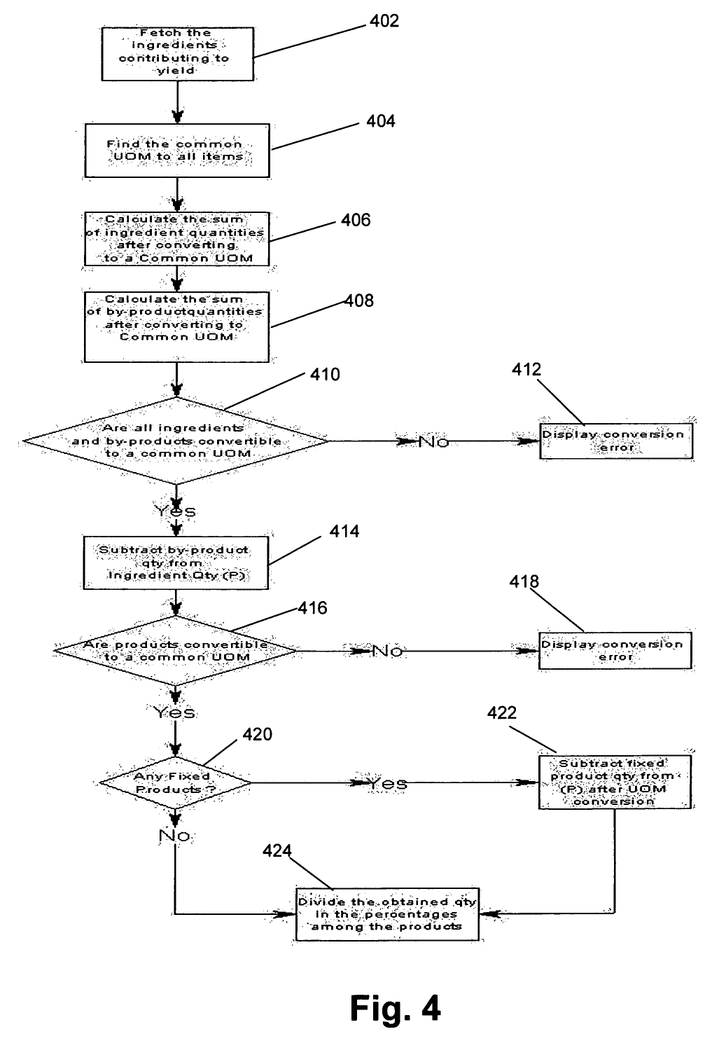

FIG. 4 is a flow diagram of the functionality of system 10 in accordance with one embodiment when determining product quantity for a formula that results in at least two products. In one embodiment, the functionally of FIG. 4 is executed in one of three situations: (1) when a new formula is created; (2) when an ingredient or byproduct quantity is changed; or (3) when the percentages for the output products is changed. In one embodiment, the functionality of the flow diagram of FIG. 4 is implemented by software stored in memory and executed by a processor. In other embodiments, the functionality can be performed by hardware, or any combination of hardware and software.

At 402, the ingredients contributing to the yield are fetched. In one embodiment, the ingredients that compose the formula are stored in database 14 as parameter 15.

At 404, a common unit of measure (“UOM”) is determined for all of the ingredients. For example, all ingredients should be in pounds, liters, etc.

At 406, the sum of the ingredient quantities is calculated.

At 408, the sum of the byproduct quantities is calculated.

At 410, it is determined if all of the ingredients and byproducts are convertible to a common UOM. If not, at 412 a conversion error is displayed.

At 414, the sum of the byproduct quantity is subtracted from the sum of the ingredient quantity.

At 416, it is determined if the products are convertible to a common UOM. If not, at 418 a conversion error is displayed.

At 420, it is determined if any of the products are fixed. If yes, at 422 the fixed product quantity is subtracted from the quantity of the remaining products. Flow continues to 424.

Finally, at 424, the obtained quantity is divided in the percentages among the products to obtain the quantity for each of the products that are generated by the formula. The percentages are entered on user interface 300 at FIG. 3 in one embodiment.

Several embodiments are specifically illustrated and/or described herein. However, it will be appreciated that modifications and variations of are covered by the above teachings and within the purview of the appended claims without departing from the spirit and intended scope of the invention.

What is claimed is:

1. A method of determining product quantities for a process manufacturing formula that generates a first product and a second product, the method comprising:
receiving a first quantity of a first ingredient and a second quantity of a second ingredient, wherein the first and second ingredients contribute to a formula yield;
receiving a third quantity of a byproduct of the formula;
receiving a first percentage of the formula for the first product and a second percentage of the formula for the second product; and
determining a first product quantity based on the first quantity, the second quantity, the third quantity and the first percentage, wherein the determining is performed dynamically upon a change in the first quantity.

2. The method of claim 1, further comprising receiving a fourth quantity of a third ingredient, wherein the third ingredient does not contribute to the formula yield.

3. The method of claim 1, wherein the determining the first product quantity comprises:
determining a first sum of ingredients that contribute to the formula yield;
determining a second sum of byproducts for the formula;
subtracting the second sum from the first sum; and
multiplying the subtracted sum by the first percentage.

4. The method of claim 1, wherein the first quantity, the second quantity, the third quantity, the first percentage and the second percentage are received from an Enterprise Resource Planning system.

5. The method of claim 1, wherein the determining is automatically executed when a new formula is created.

6. The method of claim 1, wherein the determining is automatically executed when the first, second or third quantity is changed.

7. The method of claim 1, wherein the determining is automatically executed when the first percentage or the second percentage is changed.

8. The method of claim 1, wherein the determining comprises:
determining if any output products are fixed; and
if one or more output products are fixed, subtracting a fixed product quantity from a remaining products quantity.

9. The method of claim 1, further comprising determining a second product quantity based on the first quantity, the second quantity, the third quantity and the second percentage.

10. The method of claim 9, wherein the formula generates a third product, further comprising:
receiving a third percentage of the formula for the third product; and
determining a third product quantity based on the first quantity, the second quantity, the third quantity and the third percentage.

11. The method of claim 1, wherein the wherein the determining is performed dynamically upon a change in the first percentage.

12. A computer readable media having instructions stored thereon that, when executed by a processor, causes the processor to determine product quantities for a process manufacturing formula that generates a first product and a second product by:
receiving a first quantity of a first ingredient and a second quantity of a second ingredient, wherein the first and second ingredients contribute to a formula yield;
receiving a third quantity of a byproduct of the formula;
receiving a first percentage of the formula for the first product and a second percentage of the formula for the second product; and
determining a first product quantity based on the first quantity, the second quantity, the third quantity and the first percentage;
wherein the determining is performed dynamically upon a change in the first quantity.

13. The computer readable media of claim 12, the instructions further causing the processor to:
receive a fourth quantity of a third ingredient, wherein the third ingredient does not contribute to the formula yield.

14. The computer readable media of claim 12, wherein the determining the first product quantity comprises:
determining a first sum of ingredients that contribute to the formula yield;
determining a second sum of byproducts for the formula;
subtracting the second sum from the first sum; and
multiplying the subtracted sum by the first percentage.

15. The method of claim 12, wherein the determining the first product quantity comprises:
determining if any output products are fixed; and
if one or more output products are fixed, subtracting a fixed product quantity from a remaining products quantity.

16. A system for determining product quantities for a process manufacturing formula that generates a first product and a second product, the system comprising:
means for receiving a first quantity of a first ingredient and a second quantity of a second ingredient, wherein the first and second ingredients contribute to a formula yield;
means for receiving a third quantity of a byproduct of the formula;
means for receiving a first percentage of the formula for the first product and a second percentage of the formula for the second product; and
means for determining a first product quantity based on the first quantity, the second quantity, the third quantity and the first percentage;
wherein the means for determining is performed dynamically upon a change in the first quantity.

17. A system for determining product quantities for a process manufacturing formula that generates a first product and a second product, the system comprising:
a processor; and
a computer readable media coupled to the processor, the computer readable media storing a first quantity of a first ingredient, a second quantity of a second ingredient, wherein the first and the second ingredients contribute to a formula yield, a third quantity of a byproduct of the formula, and a first percentage of the formula for the first product and a second percentage of the formula for the second product;
wherein the computer readable media stores instructions that when executed by the processor cause the processor to determine a first product quantity based on the first quantity, the second quantity, the third quantity and the first percentage;
wherein the determining is performed dynamically upon a change in the first quantity.

18. The system of claim 17, the instructions further causing the processor to:
receive a fourth quantity of a third ingredient, wherein the third ingredient does not contribute to the formula yield.

19. The system of claim 17, wherein the determine the first product quantity comprises:
determining a first sum of ingredients that contribute to the formula yield;
determining a second sum of byproducts for the formula;
subtracting the second sum from the first sum; and
multiplying the subtracted sum by the first percentage.

20. The system of claim 17, wherein the determine the first product quantity comprises:
determining if any output products are fixed; and
if one or more output products are fixed, subtracting a fixed product quantity from a remaining products quantity.
